(19) United States
(12) Patent Application Publication
(10) Pub. No.: US 2023/0069005 A1
(43) Pub. Date: Mar. 2, 2023

(54) VEHICLE CONTROL DEVICE, CONVOY TRAVEL MANAGEMENT DEVICE, AND CONVOY TRAVEL MANAGEMENT METHOD

(71) Applicant: Mitsubishi Electric Corporation, Tokyo (JP)

(72) Inventors: Ayako OYANAGI, Tokyo (JP); Yoshihiro NAKAI, Kobe-shi (JP); Masao IWATA, Tokyo (JP); Hideki FUKUHARA, Tokyo (JP)

(73) Assignee: Mitsubishi Electric Corporation, Tokyo (JP)

(21) Appl. No.: 17/795,108

(22) PCT Filed: Mar. 17, 2020
(86) PCT No.: PCT/JP2020/011582

§ 371 Date: Jul. 25, 2022

(51) Int. Cl. G08G 1/00

(52) U.S. Cl. CPC G08G 1/22

(57) ABSTRACT

A convoy forming unit uses driving control information collected from vehicles to determine a traveling order in a convoy of the vehicles so that vehicles that can be leading vehicles are disposed at a head of the convoy and an inside of the convoy. When notified of occurrence of a cut-in vehicle from any of the vehicles performing convoy travel in accordance with the traveling order, a convoy managing unit uses the driving control information to determine a new leading vehicle from among following vehicles, and divides the convoy into a first convoy ahead of the cut-in vehicle and a second convoy behind the cut-in vehicle. A convoy control unit notifies the new leading vehicle of traveling control information including an instruction to cause the cut-in vehicle to cut in front of the new leading vehicle and an instruction to be a leading vehicle of the second convoy.

### TECHNICAL FIELD

The present disclosure relates to a vehicle control device, a convoy travel management device, and a convoy travel management method.

### BACKGROUND ART

There has been proposed a technique related to convoy travel in which a plurality of vehicles having the same destination form a convoy and one or more following vehicles travel following a leading vehicle of the convoy. Vehicles performing convoy travel and another vehicle not participating in the convoy travel are mixed on the road, and the another vehicle may cut into the convoy. When a cut-in vehicle occurs to the convoy, it is difficult for the following vehicles in the convoy to follow the leading vehicle. Therefore, when a cut-in vehicle occurs, a vehicle group control device described in Patent Literature 1 divides a convoy into a part in front of the cut-in vehicle and a part behind the cut-in vehicle, and thereby reorganizes the convoy as separate convoys.

### CITATION LIST

### Patent Literatures

Patent Literature 1: JP 2019-96177 A

### SUMMARY OF INVENTION

### Technical Problem

In Patent Literature 1, only a case where all the vehicles constituting the convoy can be the leading vehicle of the convoy, that is, a case where all the vehicles can travel independently to the destination by a driving control function such as autonomous driving, remote driving, or manual driving is assumed. In this assumption, even if the convoy is divided into a part in front of the cut-in vehicle and a part behind the cut-in vehicle and thereby reorganized as separate convoys, each of the convoys can travel to the destination.

In the convoy travel, it is not necessary for all the vehicles constituting the convoy to have autonomous driving, remote driving, manual driving, or the like, and it is sufficient that at least a leading vehicle has these driving control functions. It is sufficient that the following vehicles have a driving control function for traveling following the leading vehicle. As described above, the convoy may be formed by a plurality of vehicles having different driving control functions. Here, let's assume that a vehicle behind a cut-in vehicle is a vehicle capable of only following-travel driving and manual driving, and only occupants incapable of driving (drunken state, extreme fatigue state, or the like) are riding in the vehicle. In this assumption, if the vehicle group control device described in Patent Literature 1 divides a convoy into a part in front of the cut-in vehicle and a part behind the cut-in vehicle and thereby reorganizes the convoy as separate convoys, the vehicles behind the cut-in vehicle cannot travel following the original preceding vehicle after the division, and thus have to stop and cannot continue the convoy travel.

The present disclosure has been made to solve the above problem, and an object of the present disclosure is to cause, when a cut-in vehicle occurs to the convoy, vehicles behind the cut-in vehicle to continue convoy travel.

### Solution to Problem

A vehicle control device according to the present disclosure includes: a vehicle state managing unit to manage information indicating a driving control function of a host vehicle and information indicating a state of an occupant of the host vehicle as driving control information and notify a convoy travel management server of the driving control information; a cut-in vehicle detecting unit to notify the convoy travel management server of cut-in vehicle information when detecting occurrence of a cut-in vehicle to a convoy including the host vehicle; and a traveling control unit to, in a case where the convoy travel management server determines a traveling order in the convoy of a plurality of vehicles including the host vehicle so that a vehicle and another vehicle each of which can be a leading vehicle are respectively disposed at a head of the convoy and an inside of the convoy using driving control information collected from each of the plurality of vehicles, and where the convoy travel management server notifies each of the plurality of vehicles of traveling order information indicating the traveling order, cause the host vehicle to perform convoy travel in accordance with the traveling order indicated by the notification, and to, in a case where the convoy travel management server determines, from among following vehicles that are following a leading vehicle of the convoy, a new leading vehicle that can be another leading vehicle using the driving control information in response to notification of cut-in vehicle information from any of the plurality of vehicles, and where the convoy travel management server divides the convoy into a first convoy ahead of the cut-in vehicle and a second convoy behind the cut-in vehicle when the cut-in vehicle continues cutting in, and notifies the new leading vehicle of traveling control information including an instruction to cause the cut-in vehicle to cut in front of the new leading vehicle and an instruction to be a leading vehicle of the second convoy, cause the cut-in vehicle to cut in front of the host vehicle and set the host vehicle as the leading vehicle of the second convoy when the host vehicle is the new leading vehicle.

### Advantageous Effects of Invention

The present disclosure causes a cut-in vehicle to cut in front of a vehicle that can be a leading vehicle in the convoy, and thus vehicles behind the cut-in vehicle can continue convoy travel as the second convoy.

### BRIEF DESCRIPTION OF DRAWINGS

FIG. 1 is a diagram illustrating an example of a convoy in which vehicles constituting the convoy have different driving control functions.

FIG. 2 is a diagram for explaining a problem in a case where a cut-in vehicle cuts in front of a vehicle that cannot be a leading vehicle in the convoy illustrated in FIG. 1.

FIG. 3 is a diagram illustrating a configuration example of a convoy travel management system according to a first embodiment.

FIG. 4 is a block diagram illustrating a configuration example of a convoy travel management server according to the first embodiment.

FIG. 5 is a table illustrating an example of a traveling order determined on the basis of driving control information.

FIG. 6 is a flowchart illustrating an operation example of a convoy managing unit and a convoy control unit in a case (1) where a cut-in vehicle newly occurs.

FIG. 7 is a flowchart illustrating an operation example of the convoy managing unit and the convoy control unit in a case (2) where the cut-in vehicle stops cutting in.

FIG. 8 is a flowchart illustrating an operation example of the convoy managing unit and the convoy control unit in a case (3) where the cut-in vehicle continues cutting in.

FIG. 9 is a flowchart illustrating an operation example of the convoy managing unit and the convoy control unit in a case (4) where the cut-in vehicle continues cutting in and then stops cutting in.

FIGS. 10A, 10B, and 10C are tables illustrating examples of convoy configuration information.

FIG. 11 is a block diagram illustrating a configuration example of a vehicle control device according to the first embodiment.

FIG. 12 is a flowchart illustrating an operation example of the convoy travel management system according to the first embodiment.

FIGS. 13A and 13B are diagrams each illustrating a hardware configuration example of the convoy travel management server according to the first embodiment.

FIGS. 14A and 14B are diagrams each illustrating a hardware configuration example of the vehicle control device according to the first embodiment.

FIG. 15 is a diagram illustrating a configuration example of a convoy travel management system according to a second embodiment.

FIG. 16 is a block diagram illustrating a configuration example of a convoy travel management device according to the second embodiment.

FIG. 17 is a flowchart illustrating an operation example of a cut-in acceptability determining unit and a convoy managing unit in a case (11) where a cut-in vehicle newly occurs.

FIG. 18 is a flowchart illustrating an operation example of the convoy managing unit in a case (12) where the cut-in vehicle stops cutting in.

FIG. 19 is a flowchart illustrating an operation example of the convoy managing unit in a case (13) where the cut-in vehicle continues cutting in.

FIG. 20 is a flowchart illustrating an operation example of the convoy managing unit in a case (14) where the cut-in vehicle continues cutting in and then stops cutting in.

FIGS. 21A and 21B are diagrams each illustrating a hardware configuration example of the convoy travel management device according to the second embodiment.

### DESCRIPTION OF EMBODIMENTS

In order to explain the present disclosure in more detail, modes for carrying out the present disclosure will be described below with reference to the accompanying drawings.

### First Embodiment

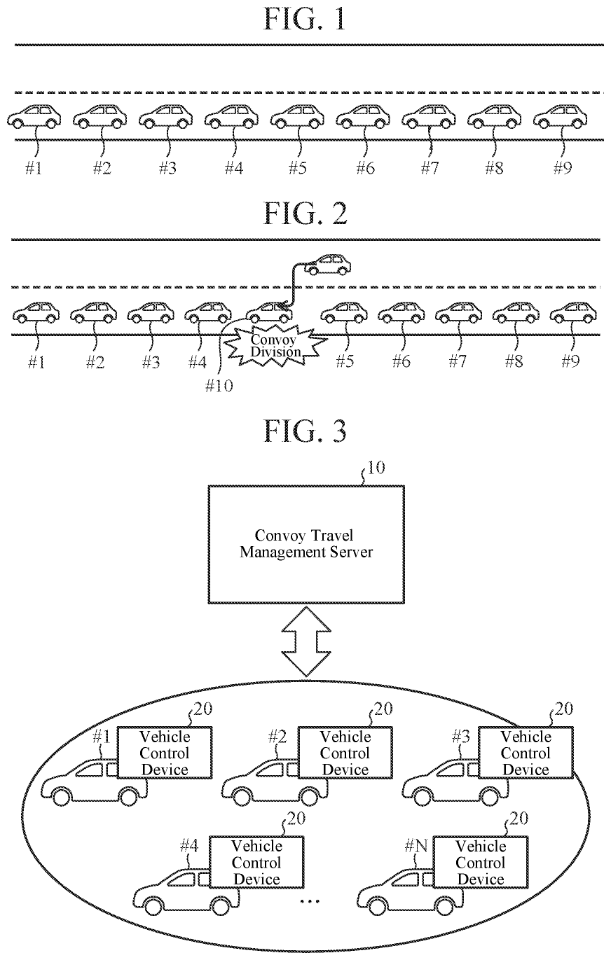

FIG. 1 is a diagram illustrating an example of a convoy in which vehicles constituting the convoy have different driving control functions. In FIG. 1, a leading vehicle #1 is a vehicle having a driving control function of at least one of autonomous driving, remote driving, and manual driving. Vehicles #2 to #9 are vehicles each having a driving control function only for following-travel driving and manual driving. The vehicle #2 follows the leading vehicle #1 by following-travel driving, the vehicle #3 follows the preceding vehicle #2 by following-travel driving, the vehicle #4 follows the preceding vehicle #3 by following-travel driving, the vehicle #5 follows the preceding vehicle #4 by following-travel driving, the vehicle #6 follows the preceding vehicle #5 by following-travel driving, the vehicle #7 follows the preceding vehicle #6 by following-travel driving, the vehicle #8 follows the preceding vehicle #7 by following-travel driving, and the vehicle #9 follows the preceding vehicle #8 by following-travel driving. As a result, the leading vehicle #1 and the following vehicles #2 to #9 are performing convoy travel.

FIG. 2 is a diagram for explaining a problem in a case where a cut-in vehicle #10 cuts in front of the vehicle #5 that cannot be a leading vehicle in the convoy illustrated in FIG. 1. Since only drunken persons are riding on the vehicle #5, manual driving is impossible. Therefore, when the vehicle #5 separates from the convoy, the vehicle #5 cannot travel, that is, cannot be a leading vehicle. As illustrated in FIG. 2, when the cut-in vehicle #10 cuts in between the vehicle #4 and the vehicle #5, the vehicle #5 loses sight of the preceding vehicle #4 and separates from the convoy. Since the occupants of the vehicle #5 are in a manual driving impossible state, the vehicle #5 has to stop. Then, since the vehicles #6 to #9 following the vehicle #5 also stop, the convoy travel cannot be continued.

A convoy travel management system according to the present disclosure continues the convoy travel by the order of the convoy travel and by traveling control of the vehicles in the convoy travel even when a vehicle outside the convoy cuts in the convoy in the convoy travel including the vehicles having different driving control functions. Further, traveling of the vehicle outside the convoy is not disturbed, and the degree of freedom of the traveling of the vehicle outside the convoy is increased.

FIG. 3 is a block diagram illustrating a configuration example of a convoy travel management system according to a first embodiment. The convoy travel management system includes a convoy travel management server 10 and a plurality of vehicle control devices 20. The vehicle control device 20 is mounted on a vehicle. In FIG. 3, the vehicle control device 20 is mounted on each of vehicles #1 to #N. Here, N is an integer greater than or equal to 2. Here, the vehicles #1 to #N are vehicles having the same destination and scheduled to perform convoy travel. Note that the vehicles #1 to #N may be vehicles having the same waypoint.

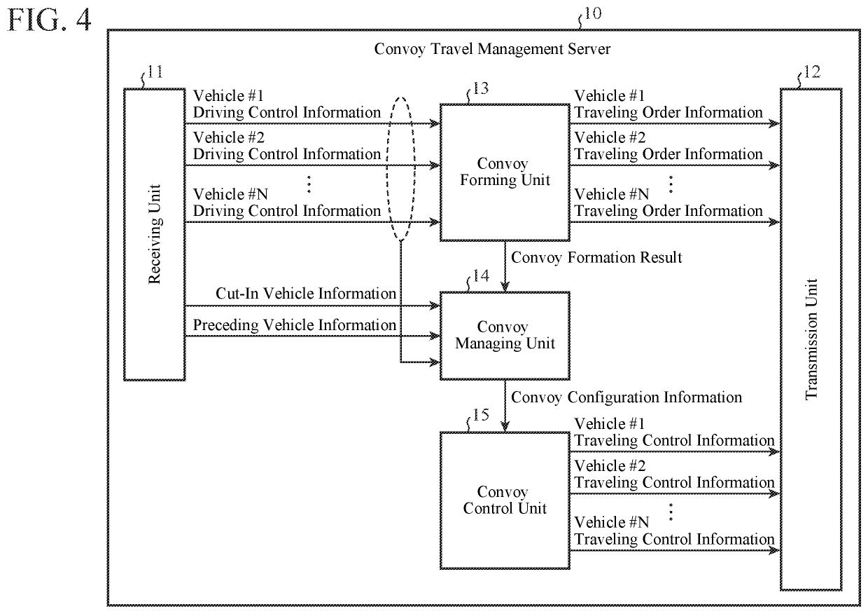

FIG. 4 is a block diagram illustrating a configuration example of the convoy travel management server 10 according to the first embodiment. The convoy travel management server 10 includes a receiving unit 11, a transmission unit 12, a convoy forming unit 13, a convoy managing unit 14, and a convoy control unit 15.

The receiving unit 11 collects, from the vehicles #1 to #N, driving control information including both information indicating a driving control function of each of the vehicles and information indicating a state of an occupant riding on each of the vehicles. The driving control function refers to autonomous driving, remote driving, following-travel driving, and manual driving. The occupant state includes the number of occupants, the number of occupants capable of driving, and a health state of each of the occupants. The receiving unit 11 outputs the collected driving control information of the vehicles #1 to #N to the convoy forming unit 13 and the convoy managing unit 14. Further, the receiving unit 11 receives cut-in vehicle information and preceding vehicle information transmitted from the vehicles #1 to #N. The receiving unit 11 outputs the received cut-in vehicle information and preceding vehicle information to the convoy managing unit 14.

The transmission unit 12 transmits traveling order information for the vehicles #1 to #N generated by the convoy forming unit 13 to each of the vehicle control devices 20 of the vehicles #1 to #N. In addition, the transmission unit 12 transmits traveling control information for the vehicles #1 to #N generated by the convoy control unit 15 to each of the vehicle control devices 20 of the vehicles #1 to #N.

The convoy forming unit 13 determines a traveling order in the convoy of the vehicles #1 to #N using the driving control information of the vehicles #1 to #N. The convoy forming unit 13 outputs a convoy formation result indicating the traveling order of the vehicles #1 to #N to the convoy managing unit 14. In addition, the convoy forming unit 13 outputs the traveling order information indicating the traveling order of the vehicles #1 to #N to the transmission unit 12.

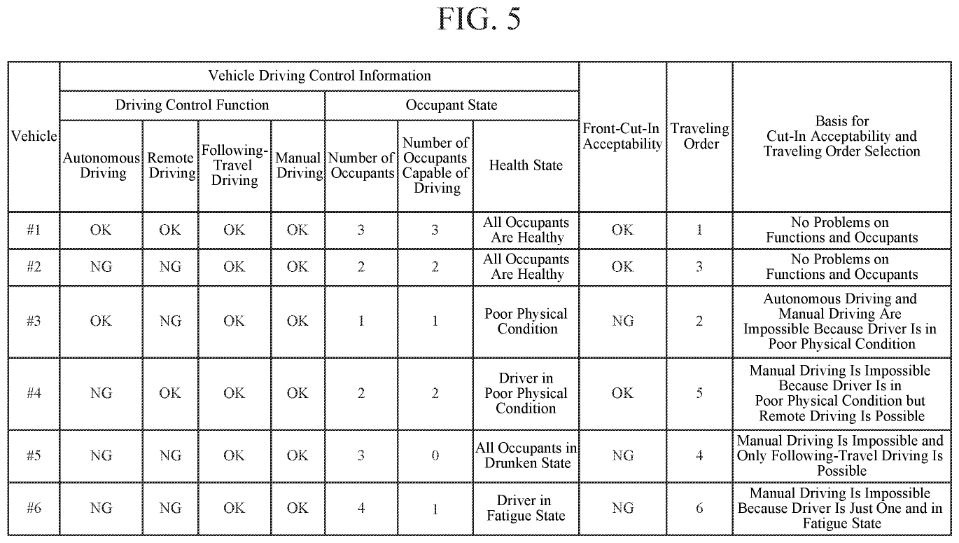

FIG. 5 is a table illustrating an example of the traveling order determined on the basis of the driving control information. The convoy forming unit 13 selects, from among the vehicles #1 to #N, a plurality of vehicles capable of at least one of autonomous driving, remote driving, and manual driving. At that time, the convoy forming unit 13 selects a vehicle on which a driver capable of manual driving is riding as a vehicle capable of manual driving. That is, the convoy forming unit 13 selects a plurality of vehicles where a cut-in vehicle can cut in front, in other words, a plurality of vehicles (in FIG. 5, vehicles #1, #2, and #4) that can be leading vehicles. Then, the convoy forming unit 13 determines a traveling order in a convoy of all the vehicles #1 to #N in such a way as to arrange the plurality of vehicles that can be leading vehicles at the head of the convoy and the inside of the convoy. For example, the convoy forming unit 13 regularly arranges the vehicles that can be the leading vehicles in the convoy. In the example of FIG. 5, since the number of vehicles that can be the leading vehicles and the number of vehicles that cannot be the leading vehicles are the same, the vehicles that can be the leading vehicles and the vehicles that cannot be the leading vehicles are alternately arranged. It is desirable that the vehicles that can be the leading vehicles and the vehicles that cannot be the leading vehicles are uniformly arranged in the convoy. By determining the traveling order in this manner, there are a plurality of points where a vehicle outside the convoy can cut in the convoy, and thus the degree of freedom of traveling of the vehicle outside the convoy, such as lane change, is increased.

Note that the driving control information of the vehicles #1 to #N may include information other than the driving control function and the occupant state. For example, the driving control information may include an intention (want to drive, may drive, not want to drive, etc.) of an occupant who may be a driver, presence or absence of an update residual of vehicle software, or the like. In addition, the convoy travel management server 10 may collect the driving control information of the vehicles #1 to #N from the vehicle control devices 20 of the vehicles #1 to #N each time the driving control information of the vehicles #1 to #N is required, or may determine the traveling order of the convoy using the driving control information of the vehicles #1 to #N collected in advance.

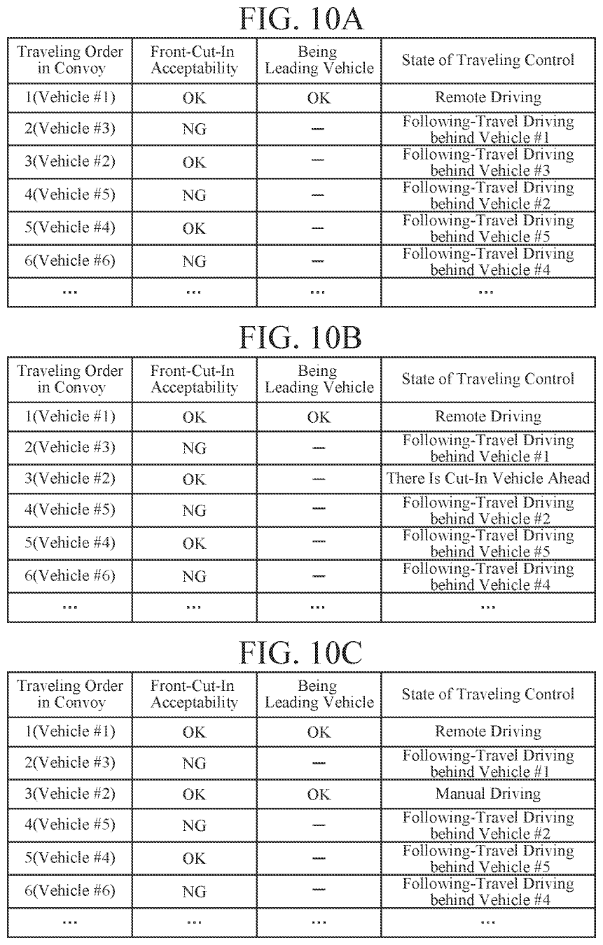

The convoy managing unit 14 holds the convoy formation result notification of which is provided from the convoy forming unit 13 as an initial state of convoy configuration information. The convoy configuration information includes the traveling order in the convoy, front-cut-in acceptability, and the states of traveling control of the vehicles #1 to #N constituting the convoy. The front-cut-in acceptability indicates whether or not the cut-in vehicle can cut in front. The state of traveling control indicates a driving control function or the like implemented by the vehicle. FIG. 10A is a table illustrating an example of convoy configuration information at the start of convoy travel. In addition, the convoy managing unit 14 determines, from among the vehicles #1 to #N performing convoy travel, a vehicle that is to cause the cut-in vehicle to cut in front thereof on the basis of the cut-in vehicle information notification of which is provided from each of the vehicle control devices 20 of the vehicles #1 to #N performing convoy travel, and updates the convoy configuration information. Further, the convoy managing unit 14 determines to set the vehicle that has caused the cut-in vehicle to cut in front thereof as a new leading vehicle on the basis of the preceding vehicle information notification of which is provided from each of the vehicle control devices 20 of the vehicles #1 to #N performing convoy travel, and updates the convoy configuration information. The convoy managing unit 14 outputs the convoy configuration information in the initial state and the updated convoy configuration information to the convoy control unit 15. Details of the operation of the convoy managing unit 14 will be described later.

The convoy control unit 15 generates traveling control information for the vehicles #1 to #N performing convoy travel on the basis of the convoy configuration information notification of which is provided from the convoy managing unit 14, and outputs the traveling control information to the transmission unit 12. The traveling control information is an instruction to continue the current traveling (instruct a vehicle to travel as the leading vehicle, or instruct a vehicle to travel while following), an instruction to increase the inter-vehicle distance, an instruction to be a leading vehicle, an instruction to follow a new leading vehicle, an instruction to return to the original convoy, or the like. Details of the operation of the convoy control unit 15 will be described later.

Next, the operation of the convoy managing unit 14 and the convoy control unit 15 when there is a cut-in vehicle will be described in detail.

When a cut-in vehicle cuts in front of a host vehicle, there is a possibility that the host vehicle cannot travel following a preceding vehicle that the host vehicle follows. However, when the host vehicle switches to a driving control function other than the following-travel driving to be a new leading vehicle and able to continue traveling to the destination, the host vehicle can cause the cut-in vehicle to cut in front thereof.

In the following description, a vehicle that has notified the convoy travel management server 10 of the cut-in vehicle information among the vehicles #1 to #N performing convoy travel is referred to as a vehicle A. In addition, among the vehicles #1 to #N, a vehicle that causes the cut-in vehicle #10 to cut in front thereof is referred to as a vehicle B.

(1) A case where a cut-in vehicle newly occurs

In the case (1), the convoy travel management server 10 determines a vehicle that increases an inter-vehicle distance to cause the cut-in vehicle to cut in the convoy, and controls the traveling of the determined vehicle and the following vehicles behind the determined vehicle.

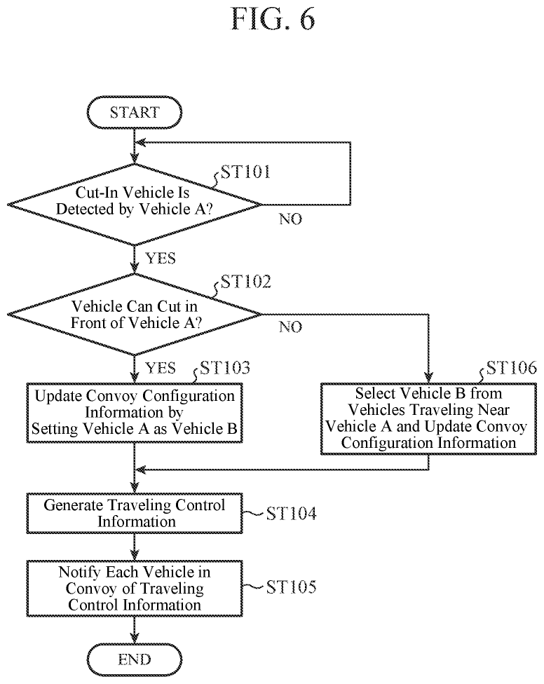

FIG. 6 is a flowchart illustrating an operation example of the convoy managing unit 14 and the convoy control unit 15 in the case (1). At the start of the operation illustrated in the flowchart of FIG. 6, the vehicles #1 to #N are in a state of starting convoy travel.

In step ST101, when the vehicle control device 20 of the vehicle A detects the presence of a cut-in vehicle that is about to cut in the convoy, the convoy managing unit 14 is notified of cut-in vehicle information from the vehicle control device 20 (step ST101 “YES”). If not notified of the cut-in vehicle information (step ST101 “NO”), the convoy managing unit 14 repeats the operation of step ST101.

In step ST102, the convoy managing unit 14 determines whether it is possible to cut in front of the vehicle A, using the driving control information of the vehicles #1 to #N. When it is possible to cut in front of the vehicle A, that is, when the vehicle A is a vehicle that can be a leading vehicle (step ST102 “YES”), the processing of the convoy managing unit 14 proceeds to step ST103. On the other hand, when it is impossible to cut in front of the vehicle A, that is, when the vehicle A cannot be a leading vehicle (step ST102 “NO”), the processing of the convoy managing unit 14 proceeds to step ST106.

In step ST103, the convoy managing unit 14 updates the convoy configuration information by setting the vehicle A as the vehicle B and setting the state of traveling control of the vehicle B to “there is a cut-in vehicle ahead”. FIG. 10B is a table illustrating an example of convoy configuration information when there is a cut-in vehicle in the convoy. In the example of FIG. 10B, there is a cut-in vehicle ahead of the vehicle #2, which is the third in the traveling order, and in a lane different from that of the vehicle #2.

In step ST104, on the basis of the convoy configuration information notification of which is provided from the convoy managing unit 14, the convoy control unit 15 generates traveling control information by which the vehicle B temporarily decelerates in such a way as to increase the inter-vehicle distance to the preceding vehicle in order to cause the cut-in vehicle to cut in front of the vehicle B. In addition, the convoy control unit 15 generates traveling control information by which the following vehicles behind the vehicle B temporarily decelerate in response to the temporary deceleration of the vehicle B.

In step ST105, the convoy control unit 15 notifies the vehicles #1 to #N in the convoy of the traveling control information via the transmission unit 12.

In step ST106, the convoy managing unit 14 selects the vehicle B traveling near the vehicle A from among the vehicles #1 to #N in the convoy. The convoy managing unit 14 updates the convoy configuration information by setting the state of traveling control of the vehicle B to “there is a cut-in vehicle ahead”. For example, when a cut-in vehicle is about to cut in front of the vehicle #5 that is the vehicle A, it is impossible to cut in front of the vehicle #5, and thus the convoy managing unit 14 selects the vehicle #2 or the vehicle #4 as the vehicle B instead.

(2) A case where a cut-in vehicle stops cutting in after occurrence of the above (1)

In the case (2), the convoy travel management server 10 causes the vehicle having kept the increased inter-vehicle distance to return to the original inter-vehicle distance.

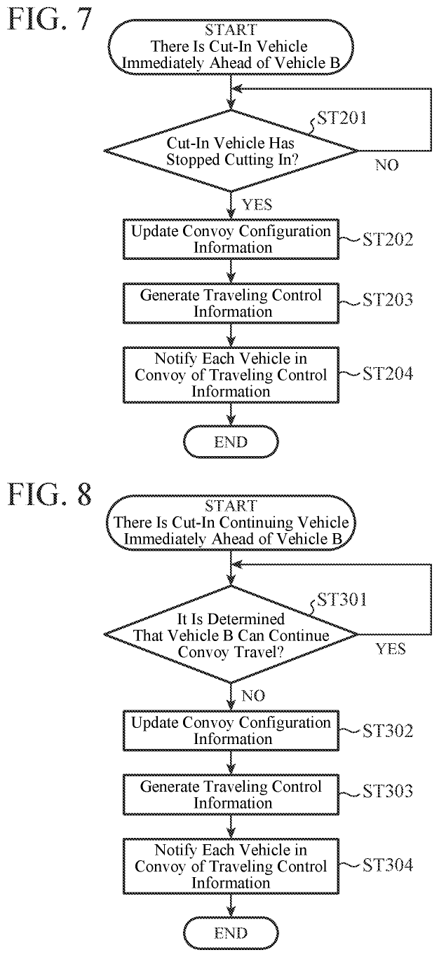

FIG. 7 is a flowchart illustrating an operation example of the convoy managing unit 14 and the convoy control unit 15 in the case (2). At the start of the operation illustrated in the flowchart of FIG. 7, there is a cut-in vehicle immediately ahead of the vehicle B in a lane different from the lane of the vehicle B.

In step ST201, when the vehicle control device 20 of the vehicle B detects that the cut-in vehicle has stopped cutting in, the convoy managing unit 14 is notified of cut-in vehicle information indicating that the cutting in is stopped from the vehicle control device 20 (step ST201 “YES”). If not notified of the cut-in vehicle information (step ST201 “NO”), the convoy managing unit 14 repeats the operation of step ST201.

In step ST202, the convoy managing unit 14 updates the convoy configuration information by setting the state of traveling control of the vehicle B to “following-travel driving behind the preceding vehicle” from “there is a cut-in vehicle ahead”. The updated convoy configuration information has contents illustrated in FIG. 10A.

In step ST203, on the basis of the convoy configuration information notification of which is provided from the convoy managing unit 14, the convoy control unit 15 generates traveling control information by which the vehicle B temporarily accelerates in such a way as to reduce the inter-vehicle distance to the preceding vehicle. In addition, the convoy control unit 15 generates traveling control information by which the following vehicles behind the vehicle B temporarily accelerate in response to the temporary acceleration of the vehicle B.

In step ST204, the convoy control unit 15 notifies the vehicles #1 to #N in the convoy of the traveling control information via the transmission unit 12.

(3) A case where the cut-in vehicle continues cutting in after occurrence of the above (1)

In the case (3), the convoy travel management server 10 sets the vehicle B as a new leading vehicle, and organizes the vehicle B and the following vehicles behind the vehicle B as a new convoy. The convoy travel management server 10 forms the new convoy when the cutting in continues in (3) instead of when the cutting in occurs in the above (1), thereby reducing the processing cost related to convoy reorganization in a case where the cut-in vehicle that is about to cut in the convoy does not actually cut in, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

FIG. 8 is a flowchart illustrating an operation example of the convoy managing unit 14 and the convoy control unit 15 in the case (3). At the start of the operation shown in the flowchart of FIG. 8, there is a cut-in vehicle immediately ahead of the vehicle B in the same lane as the vehicle B.

In step ST301, the convoy managing unit 14 determines whether or not the vehicle B can continue the convoy travel, using the preceding vehicle information notification of which is provided from the vehicle control device 20 of the vehicle B, or the like. For example, the convoy managing unit 14 determines that the vehicle B cannot continue the convoy travel when a predetermined time has elapsed from the time point at which the cutting in has occurred in the above (1). In addition, for example, when the preceding vehicle information notification of which is provided from the vehicle control device 20 of the vehicle B is information indicating that the vehicle B is likely to lose the preceding vehicle, the convoy managing unit 14 may determine that the vehicle B cannot continue the convoy travel. When the vehicle B cannot continue the convoy travel (step ST301 “NO”), the processing of the convoy managing unit 14 proceeds to step ST302, and when the vehicle B can continue the convoy travel (step ST301 “YES”), the processing of the convoy managing unit 14 returns to step ST301.

In step ST302, the convoy managing unit 14 updates the convoy configuration information by setting the state of traveling control of the vehicle B to “driving control to be performed (autonomous driving, remote driving, manual driving, or the like)” from “there is a cut-in vehicle ahead” and further setting information indicating “it is the leading vehicle”. Note that, the convoy managing unit 14 may select the driving control to be performed by the vehicle B from among autonomous driving, remote driving, and manual driving, using the driving control information of the vehicle B. FIG. 10C is a table illustrating an example of convoy configuration information when the cut-in vehicle continues cutting in. In the example of FIG. 10C, since the cut-in vehicle is continuously present ahead of the vehicle #2 which is the third in the traveling order, the vehicle #2 becomes a leading vehicle, and switches to the manual driving from the following-travel driving. When the vehicle #2 becomes a new leading vehicle, a convoy including the vehicles #1 to #6 is reorganized into a first convoy including the vehicle #1 and the vehicle #3 with the vehicle #1 as the leading vehicle and a second convoy including the vehicle #2, the vehicle #5, the vehicle #4, and the vehicle #6 with the vehicle #2 as the new leading vehicle.

In step ST303, the convoy control unit 15 generates traveling control information by which the vehicle B switches the state of traveling control from the following-travel driving to any of autonomous driving, remote driving, and manual driving to be a new leading vehicle. In addition, the convoy control unit 15 generates traveling control information by which the following vehicles behind the vehicle B form a new convoy with the vehicle B at the head.

In step ST304, the convoy control unit 15 notifies the vehicles #1 to #N in the convoy of the traveling control information via the transmission unit 12.

After the cut-in vehicle cuts in the convoy, the vehicle B continues traveling to the destination as the new leading vehicle unless the cut-in vehicle stops cutting in.

(4) A case where the cut-in vehicle stops cutting in after the new convoy formation of the above (3)

In the case (4), the convoy travel management server 10 returns the first convoy and the second convoy separated by the cut-in vehicle to the original one convoy.

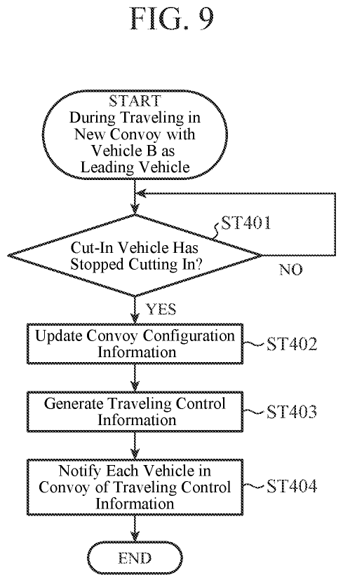

FIG. 9 is a flowchart illustrating an operation example of the convoy managing unit 14 and the convoy control unit 15 in the case (4). At the start of the operation illustrated in the flowchart of FIG. 9, the first convoy and the second convoy with the vehicle B as the new leading vehicle are traveling. Further, the cut-in vehicle is traveling between the first convoy and the second convoy.

In step ST401, when the vehicle control device 20 of the vehicle B detects that the cut-in vehicle traveling ahead of the vehicle B has stopped cutting in, notification of cut-in vehicle information indicating that the cutting in is stopped is provided from the vehicle control device 20 to the convoy managing unit 14 (step ST401 “YES”). If not notified of the cut-in vehicle information (step ST401 “NO”), the convoy managing unit 14 repeats the operation of step ST401.

In step ST402, the convoy managing unit 14 updates the convoy configuration information by setting the state of traveling control of the vehicle B to “travel following the preceding vehicle” from the “driving control to be performed” and further setting information indicating “it is not the leading vehicle”. The updated convoy configuration information has contents illustrated in FIG. 10A.

In step ST403, on the basis of the convoy configuration information notification of which is provided from the convoy managing unit 14, the convoy control unit 15 generates traveling control information by which the vehicle B temporarily accelerates in such a way as to reduce the inter-vehicle distance to the following vehicle at the end of the first convoy in order for the vehicle B to travel following the following vehicle. In addition, the convoy control unit 15 generates traveling control information by which the following vehicles behind the vehicle B temporarily accelerate in response to the temporary acceleration of the vehicle B.

In step ST404, the convoy control unit 15 notifies the vehicles #1 to #N in the convoy of the traveling control information via the transmission unit 12.

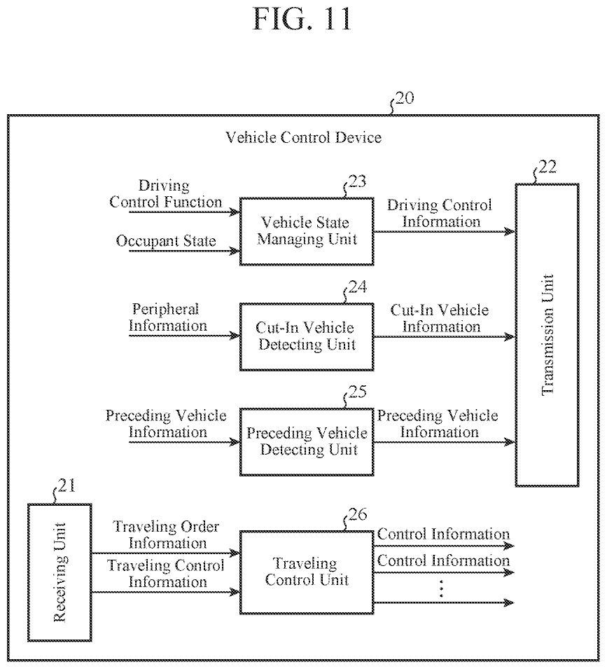

FIG. 11 is a block diagram illustrating a configuration example of the vehicle control device 20 according to the first embodiment. The vehicle control device 20 includes a receiving unit 21, a transmission unit 22, a vehicle state managing unit 23, a cut-in vehicle detecting unit 24, a preceding vehicle detecting unit 25, and a traveling control unit 26.

The receiving unit 21 receives the traveling order information for the host vehicle from the convoy travel management server 10. The receiving unit 21 outputs the received traveling order information to the traveling control unit 26. Further, the receiving unit 21 receives the traveling control information for the host vehicle from the convoy travel management server 10. The receiving unit 21 outputs the received traveling control information to the traveling control unit 26.

The transmission unit 22 transmits the driving control information of the host vehicle output by the vehicle state managing unit 23 to the convoy travel management server 10. In addition, the transmission unit 22 transmits the cut-in vehicle information output by the cut-in vehicle detecting unit 24 to the convoy travel management server 10. In addition, the transmission unit 22 transmits the preceding vehicle information output by the preceding vehicle detecting unit 25 to the convoy travel management server 10.

The vehicle state managing unit 23 manages information indicating a driving control function of the host vehicle and information indicating a state of an occupant riding on the host vehicle. Management refers to periodically acquiring information on the driving control function and the occupant state from the host vehicle and thereby updating the information. The vehicle state managing unit 23 outputs information indicating the latest driving control function and information indicating the latest occupant state to transmission unit 22 as driving control information. Note that the vehicle state managing unit 23 desirably transmits the changed driving control information to the convoy travel management server 10 via the transmission unit 22 as needed when the content of the driving control information changes, for example, when a change occurs in the occupant state or when an abnormality or a failure occurs in the host vehicle.

The cut-in vehicle detecting unit 24 acquires peripheral information from the host vehicle, and detects the presence or absence of a cut-in vehicle around the host vehicle using the acquired peripheral information. The peripheral information is information indicating a lighting state of a blinker of a peripheral vehicle, information detected by a sensor mounted on the host vehicle, route information of a peripheral vehicle received from the peripheral vehicle, or the like. For example, the cut-in vehicle detecting unit 24 detects a cut-in vehicle that is about to cut in a convoy and a cut-in vehicle that is about to stop cutting in the convoy on the basis of a lighting state of a blinker of a peripheral vehicle. In addition, for example, on the basis of the information detected by the sensor, the cut-in vehicle detecting unit 24 detects a peripheral vehicle approaching the host vehicle as a cut-in vehicle, and detects a cut-in vehicle that is about to recede from the host vehicle as a cut-in vehicle that stops cutting in. In addition, for example, the cut-in vehicle detecting unit 24 predicts a lane change due to a route change by a peripheral vehicle on the basis of route information received from the peripheral vehicle, and detects a cut-in vehicle that is about to cut in the convoy and a cut-in vehicle that is about to stop cutting in the convoy on the basis of the change-target lane. The cut-in vehicle detecting unit 24 generates cut-in vehicle information, and outputs the cut-in vehicle information to the transmission unit 22. The cut-in vehicle information includes information indicating that a cut-in vehicle that is about to cut in a convoy has been detected, information indicating that a cut-in vehicle that is about to cut in a convoy has stopped cutting in, and information indicating that a cut-in vehicle that is cutting in a convoy has stopped cutting in.

When the host vehicle travels while following in a convoy, the preceding vehicle detecting unit 25 generates preceding vehicle information indicating a detection situation of the preceding vehicle that is followed and outputs the preceding vehicle information to the transmission unit 22. The preceding vehicle information includes information indicating that the preceding vehicle can be correctly followed by following-travel driving which is a driving control function of the host vehicle, information indicating that there is a possibility of losing sight of the preceding vehicle because there is a cut-in vehicle not included in the convoy between the preceding vehicle and the host vehicle, and information indicating that the preceding vehicle has been lost.

The traveling control unit 26 notifies each component (not illustrated) in the host vehicle of control information on the basis of the traveling order information and the traveling control information for the host vehicle notification of which is provided from the convoy travel management server 10. At least one of autonomous driving, remote driving, following-travel driving, and manual driving is performed by each component in the host vehicle. For example, each component in the host vehicle performs travel in such a way as to follow a designated preceding vehicle on the basis of the control information from the traveling control unit 26. In addition, for example, each component in the host vehicle temporarily decelerates the vehicle speed in order to increase the inter-vehicle distance, and restores the vehicle speed after a predetermined inter-vehicle distance is achieved, on the basis of the control information from the traveling control unit 26.

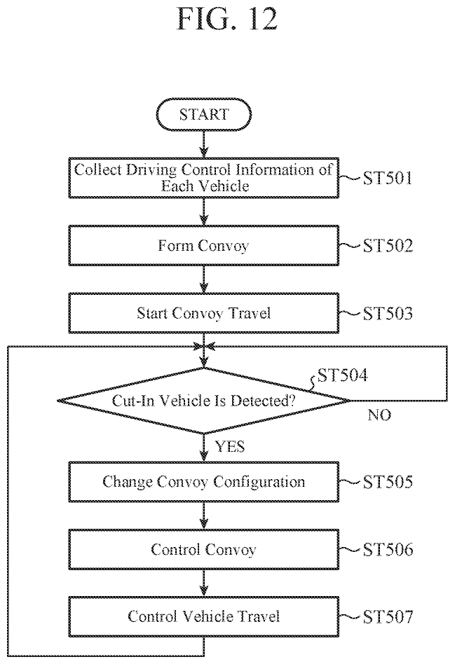

FIG. 12 is a flowchart illustrating an operation example of the convoy travel management system according to the first embodiment.

In step ST501, the transmission unit 22 of each of the vehicle control devices 20 of the vehicles #1 to #N notifies the convoy travel management server 10 of driving control information. The receiving unit 11 of the convoy travel management server 10 collects the driving control information from each of the vehicle control devices 20 of the vehicles #1 to #N.

In step ST502, the convoy forming unit 13 of the convoy travel management server 10 determines the traveling order of the vehicles #1 to #N using the collected driving control information of the vehicles #1 to #N, to form a convoy. The transmission unit 12 transmits traveling order information for the vehicles #1 to #N to each of the vehicle control devices 20 of the vehicles #1 to #N.

In step ST503, the traveling control unit 26 of each of the vehicle control devices 20 of the vehicles #1 to #N starts convoy travel in the traveling order indicated by the traveling order information notification of which is provided from the convoy travel management server 10.

In step ST504, when detecting the occurrence or stop of a cut-in vehicle (step ST504 “YES”), the cut-in vehicle detecting unit 24 of each of the vehicle control devices 20 of the vehicles #1 to #N performing convoy travel notifies the convoy travel management server 10 of cut-in vehicle information indicating the occurrence or stop of the cutting in via the transmission unit 22. If the cut-in vehicle detecting unit 24 does not detect the occurrence or stop of a cut-in vehicle (step ST504 “NO”), the traveling control unit 26 continues the convoy travel.

In step ST505, when notified of the cut-in vehicle information from the vehicle control device 20 mounted on any of the vehicles #1 to #N, the convoy managing unit 14 of the convoy travel management server 10 changes convoy configuration information.

In step ST506, the convoy control unit 15 generates traveling control information for the vehicles #1 to #N on the basis of the convoy configuration information changed in step ST505. The transmission unit 12 transmits the traveling control information for the vehicles #1 to #N to each of the vehicle control devices 20 of the vehicles #1 to #N.

In step ST507, the traveling control unit 26 of each of the vehicle control devices 20 of the vehicles #1 to #N controls traveling of the host vehicle on the basis of the traveling control information notification of which is provided from the convoy travel management server 10.

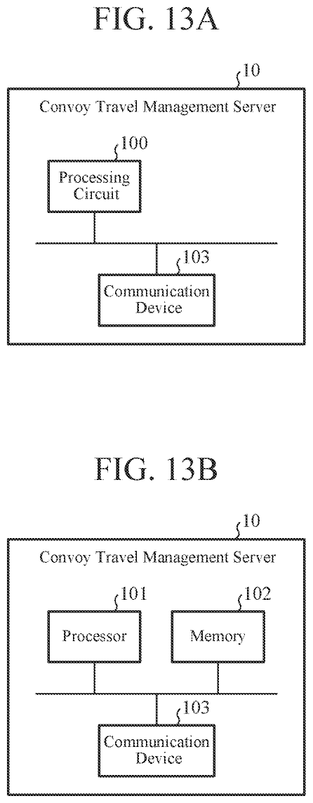

FIGS. 13A and 13B are diagrams each illustrating a hardware configuration example of the convoy travel management server 10 according to the first embodiment. The receiving unit 11 and the transmission unit 12 in the convoy travel management server 10 correspond to a communication device 103. The functions of the convoy forming unit 13, the convoy managing unit 14, and the convoy control unit 15 in the convoy travel management server 10 are implemented by a processing circuit. That is, the convoy travel management server 10 includes a processing circuit for implementing the above functions. The processing circuit may be a processing circuit 100 as dedicated hardware, or may be a processor 101 that executes a program stored in a memory 102.

As illustrated in FIG. 13A, in a case where the processing circuit is dedicated hardware, the processing circuit 100 corresponds to, for example, a single circuit, a composite circuit, a programmed processor, a parallel programmed processor, an application specific integrated circuit (ASIC), a field programmable gate array (FPGA), or a combination thereof. The functions of the convoy forming unit 13, the convoy managing unit 14, and the convoy control unit 15 may be implemented by a plurality of processing circuits 100, or the functions of the respective units may be collectively implemented by one processing circuit 100.

As illustrated in FIG. 13B, when the processing circuit is the processor 101, the functions of the convoy forming unit 13, the convoy managing unit 14, and the convoy control unit 15 are implemented by software, firmware, or a combination of software and firmware. Software or firmware is described as a program and stored in the memory 102. The processor 101 implements the functions of the respective units by reading and executing the program stored in the memory 102. That is, the convoy forming unit 13, the convoy managing unit 14, and the convoy control unit 15 include the memory 102 for storing a program that results in execution of steps illustrated in the flowcharts of FIGS. 6 to 9 and 12 when executed by the processor 101. Furthermore, it can also be said that this program causes a computer to execute procedures or methods performed by the convoy forming unit 13, the convoy managing unit 14, and the convoy control unit 15.

Note that the functions of the convoy forming unit 13, the convoy managing unit 14, and the convoy control unit 15 may be partially implemented by dedicated hardware, and partially implemented by software or firmware. In this manner, the processing circuit in the convoy travel management server 10 can implement the above-described functions by hardware, software, firmware, or a combination thereof.

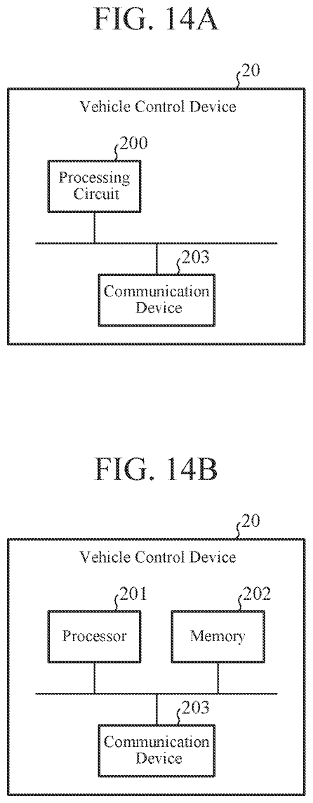

FIGS. 14A and 14B are diagrams each illustrating a hardware configuration example of the vehicle control device 20 according to the first embodiment. The receiving unit 21 and the transmission unit 22 in the vehicle control device 20 correspond to a communication device 203. The functions of the vehicle state managing unit 23, the cut-in vehicle detecting unit 24, the preceding vehicle detecting unit 25, and the traveling control unit 26 in the vehicle control device 20 are implemented by a processing circuit. That is, the vehicle control device 20 includes a processing circuit for implementing the above functions. The processing circuit may be a processing circuit 200 as dedicated hardware, or may be a processor 201 that executes a program stored in a memory 202.

As illustrated in FIG. 14A, in a case where the processing circuit is dedicated hardware, the processing circuit 200 corresponds to, for example, a single circuit, a composite circuit, a programmed processor, a parallel programmed processor, ASIC, FPGA, or a combination thereof. The functions of the vehicle state managing unit 23, the cut-in vehicle detecting unit 24, the preceding vehicle detecting unit 25, and the traveling control unit 26 may be implemented by a plurality of processing circuits 200, or the functions of the respective units may be collectively implemented by one processing circuit 200.

As illustrated in FIG. 14B, when the processing circuit is the processor 201, the functions of the vehicle state managing unit 23, the cut-in vehicle detecting unit 24, the preceding vehicle detecting unit 25, and the traveling control unit 26 are implemented by software, firmware, or a combination of software and firmware. Software or firmware is described as a program and stored in the memory 202. The processor 201 implements the functions of the respective units by reading and executing the program stored in the memory 202. That is, the vehicle state managing unit 23, the cut-in vehicle detecting unit 24, the preceding vehicle detecting unit 25, and the traveling control unit 26 include the memory 202 for storing a program that results in execution of steps illustrated in the flowchart of FIG. 12 when executed by the processor 201. It can also be said that this program causes a computer to execute procedures or methods performed by the vehicle state managing unit 23, the cut-in vehicle detecting unit 24, the preceding vehicle detecting unit 25, and the traveling control unit 26.

Note that a part of the functions of the vehicle state managing unit 23, the cut-in vehicle detecting unit 24, the preceding vehicle detecting unit 25, and the traveling control unit 26 may be implemented by dedicated hardware, and another part thereof may be implemented by software or firmware. Thus, the processing circuit in the vehicle control device 20 can implement the above functions by hardware, software, firmware, or a combination thereof.

Here, the processors 101 and 201 each correspond to a central processing unit (CPU), a processing device, an arithmetic device, a microprocessor, or the like.

Each of the memories 102 and 202 may be a nonvolatile or volatile semiconductor memory such as a random access memory (RAM), a read only memory (ROM), an erasable programmable ROM (EPROM), or a flash memory, may be a magnetic disk such as a hard disk or a flexible disk, or may be an optical disk such as a compact disc (CD) or a digital versatile disc (DVD).

As described above, the convoy travel management server 10 according to the first embodiment includes the convoy forming unit 13, the convoy managing unit 14, and the convoy control unit 15. The convoy forming unit 13 collects, from each of the plurality of vehicles #1 to #N, information indicating the driving control function of the vehicle and information indicating the state of the occupant of the vehicle as driving control information, determines the traveling order in the convoy of the vehicles #1 to #N using the collected driving control information so that a vehicle that can be a leading vehicle is disposed at a head of the convoy and an inside of the convoy, and notifies each of the vehicles #1 to #N of the traveling order information indicating the traveling order. When notified of cut-in vehicle information indicating the occurrence of a cut-in vehicle to the convoy from any of the plurality of vehicles #1 to #N performing convoy travel in accordance with the notification from the convoy forming unit 13, the convoy managing unit 14 determines, from among following vehicles that are following the leading vehicle of the convoy, a new leading vehicle that can be another leading vehicle using the driving control information. The convoy managing unit 14 divides the convoy into a first convoy ahead of the cut-in vehicle and a second convoy behind the cut-in vehicle when the cut-in vehicle continues cutting in. The convoy control unit 15 notifies the new leading vehicle determined by the convoy managing unit 14 of traveling control information including an instruction to cause the cut-in vehicle to cut in front of the new leading vehicle and an instruction to be a leading vehicle of the second convoy. Since the convoy travel management server 10 causes the cut-in vehicle to cut in front of the vehicle that can be the leading vehicle in the convoy, the vehicles behind the cut-in vehicle can continue the convoy travel as the second convoy. In addition, since the convoy of the vehicles #1 to #N does not disturb the traveling of a vehicle outside the convoy, the degree of freedom of the traveling of the vehicle outside the convoy is improved. In addition, when the cut-in vehicle that has cut in the convoy does not continue the cutting in and immediately stops the cutting in, the convoy travel management server 10 does not divide the convoy. Therefore, it is possible to reduce the processing cost related to the convoy reorganization, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

Furthermore, according to the first embodiment, the convoy forming unit 13 regularly arranges vehicles each of which can be the leading vehicle in the convoy. As a result, the convoy travel management server 10 can easily cause the cut-in vehicle to cut in at any position in the convoy. In addition, a vehicle outside the convoy easily cuts in at any position in the convoy, and thus the degree of freedom of traveling of the vehicle outside the convoy is improved.

According to the first embodiment, when notified of cut-in vehicle information indicating the occurrence of a cut-in vehicle to the convoy from any of the plurality of vehicles #1 to #N performing convoy travel in accordance with the notification from the convoy forming unit 13, the convoy managing unit 14 determines, from among following vehicles that are following the leading vehicle of the convoy, a new leading vehicle that can be another leading vehicle using the driving control information. The convoy managing unit 14 divides the convoy into the first convoy ahead of the cut-in vehicle and the second convoy behind the cut-in vehicle when the new leading vehicle cannot continue the convoy travel. As a result, the convoy travel management server 10 can reduce the processing cost related to the convoy reorganization when the cut-in vehicle that is about to cut in the convoy does not actually cut in, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

In addition, according to the first embodiment, the convoy managing unit 14 returns the first convoy and the second convoy to the original one convoy when notified of cut-in vehicle information indicating that the cut-in vehicle has stopped cutting in from any of the vehicles constituting the first convoy and the second convoy performing convoy travel in accordance with the notification from the convoy forming unit 13. The convoy control unit 15 notifies the new leading vehicle of traveling control information including an instruction to follow a rearmost vehicle of the first convoy. As a result, when the cut-in vehicle stops cutting in the convoy, the convoy travel management server 10 can return the vehicles #1 to #N to the original convoy.

The vehicle control device 20 according to the first embodiment includes the vehicle state managing unit 23, the cut-in vehicle detecting unit 24, and the traveling control unit 26. The vehicle state managing unit 23 manages information indicating a driving control function of the host vehicle and information indicating a state of an occupant of the host vehicle as driving control information, and notifies the convoy travel management server 10 of the driving control information. When detecting the occurrence of a cut-in vehicle to a convoy including the host vehicle, the cut-in vehicle detecting unit 24 notifies the convoy travel management server 10 of cut-in vehicle information. In a case where the convoy travel management server 10 determines a traveling order in the convoy of a plurality of vehicles #1 to #N including the host vehicle so that a vehicle that can be a leading vehicle is disposed at a head of the convoy and an inside of the convoy using driving control information collected from each of the plurality of vehicles #1 to #N, and where the convoy travel management server 10 notifies each of the plurality of vehicles #1 to #N of traveling order information indicating the traveling order, the traveling control unit 26 causes the host vehicle to perform convoy travel in accordance with the traveling order indicated by the notification. In addition, in a case where the convoy travel management server 10 determines, from among following vehicles that are following the leading vehicle of the convoy, a new leading vehicle that can be another leading vehicle using the driving control information in response to notification of cut-in vehicle information from any of the plurality of vehicles #1 to #N, and where the convoy travel management server 10 divides the convoy into a first convoy ahead of the cut-in vehicle and a second convoy behind the cut-in vehicle when the cut-in vehicle continues cutting in, and notifies the new leading vehicle of traveling control information including an instruction to cause the cut-in vehicle to cut in front of the new leading vehicle and an instruction to be a leading vehicle of the second convoy, the traveling control unit 26 causes the cut-in vehicle to cut in front of the host vehicle and sets the host vehicle as the leading vehicle of the second convoy when the host vehicle is the new leading vehicle. When the host vehicle is a vehicle that can be a leading vehicle in the convoy, the vehicle control device 20 causes the cut-in vehicle to cut in front of the host vehicle. Therefore, the vehicle control device 20 can continue the convoy travel with the host vehicle and the following vehicles behind the host vehicle as the second convoy. In addition, since the convoy of the vehicles #1 to #N does not disturb the traveling of a vehicle outside the convoy, the degree of freedom of the traveling of the vehicle outside the convoy is improved. In addition, when the cut-in vehicle that has cut in the convoy does not continue the cutting in and immediately stops the cutting in, the vehicle control device 20 does not divide the convoy. Therefore, it is possible to reduce the processing cost related to the convoy reorganization, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

### Second Embodiment

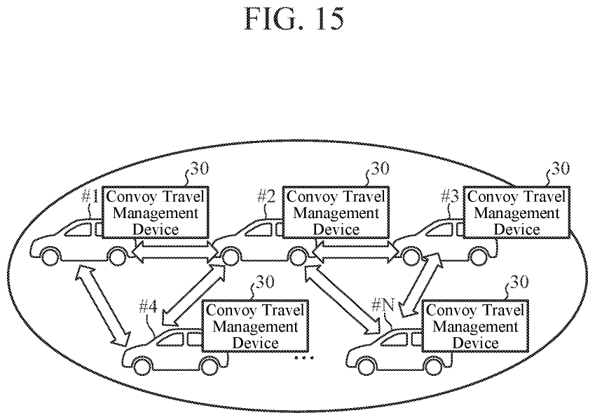

FIG. 15 is a block diagram illustrating a configuration example of a convoy travel management system according to a second embodiment. The convoy travel management system includes a convoy travel management device 30 mounted on each of a plurality of vehicles #1 to #N. Here, N is an integer greater than or equal to 2. Here, the vehicles #1 to #N are vehicles having the same destination and scheduled to perform convoy travel. Note that the vehicles #1 to #N may be vehicles having the same waypoint. Any one of the vehicles #1 to #N is a host vehicle, and each of the remaining vehicles is a different vehicle.

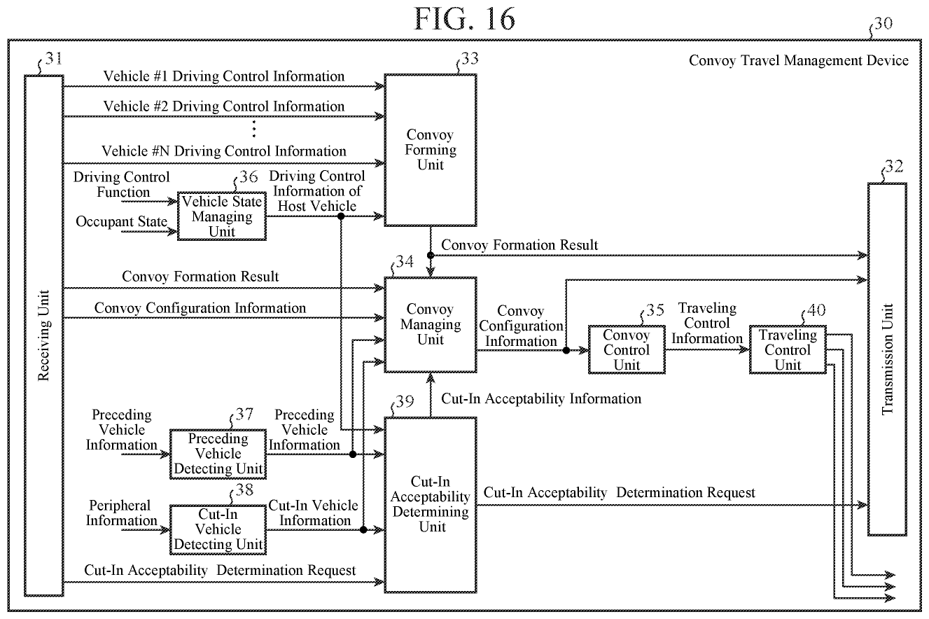

FIG. 16 is a block diagram illustrating a configuration example of the convoy travel management device 30 according to the second embodiment. The convoy travel management device 30 mounted on the host vehicle includes a receiving unit 31, a transmission unit 32, a convoy forming unit 33, a convoy managing unit 34, a convoy control unit 35, a vehicle state managing unit 36, a preceding vehicle detecting unit 37, a cut-in vehicle detecting unit 38, a cut-in acceptability determining unit 39, and a traveling control unit 40.

The receiving unit 31 receives the driving control information of the different vehicle from the convoy travel management device 30 mounted on the different vehicle, and outputs the received driving control information of the different vehicle to the convoy forming unit 33. Further, the receiving unit 31 receives the convoy formation result and the convoy configuration information from the convoy travel management device 30 mounted on the different vehicle, and outputs the received convoy formation result and the received convoy configuration information of the different vehicle to the convoy managing unit 34. In addition, the receiving unit 31 receives a cut-in acceptability determination request from the convoy travel management device 30 mounted on the different vehicle, and outputs the received cut-in acceptability determination request to the cut-in acceptability determining unit 39.

The transmission unit 32 transmits the convoy formation result of the host vehicle output from the convoy forming unit 33 and the convoy configuration information of the host vehicle output from the convoy managing unit 34 to the convoy travel management device 30 mounted on the different vehicle. In addition, the transmission unit 32 transmits a cut-in acceptability determination request output from the cut-in acceptability determining unit 39 to the convoy travel management device 30 mounted on the different vehicle.

Similarly to the convoy forming unit 13 illustrated in FIG. 4, the convoy forming unit 33 collects the driving control information from each of the convoy travel management devices 30 of the vehicles #1 to #N including the host vehicle, and determines the traveling order in the convoy of the vehicles #1 to #N. The convoy forming unit 33 notifies the convoy managing unit 34 of the host vehicle and the convoy managing unit 34 of the different vehicle of the determined traveling order as the convoy formation result.

The driving control information of the host vehicle corresponds to “first driving control information”, and the driving control information of the different vehicle corresponds to “second driving control information”.

The convoy managing unit 34 holds the convoy formation result notification of which is provided from the convoy forming unit 33 of the host vehicle or the convoy forming unit 33 of the different vehicle as an initial state of the convoy configuration information, similarly to the convoy managing unit 14 illustrated in FIG. 4. Since the convoy forming unit 33 of the host vehicle and the convoy forming unit 33 of the different vehicle determine the traveling order using the same driving control information and the same condition, the convoy formation result notification of which is provided from the convoy forming unit 33 of the host vehicle and the convoy formation result notification of which is provided from the convoy forming unit 33 of the different vehicle are the same in the initial state. When notified of cut-in acceptability information from the cut-in acceptability determining unit 39 of the host vehicle, the convoy managing unit 34 updates the convoy configuration information and notifies the convoy control unit 35 of the host vehicle and the convoy control unit 35 of the different vehicle of the updated convoy configuration information. Details of the operation of the convoy managing unit 34 will be described later.

Similarly to the convoy control unit 15 illustrated in FIG. 4, the convoy control unit 35 generates traveling control information for the host vehicle on the basis of the convoy configuration information notification of which is provided from the convoy managing unit 34 of the host vehicle. The convoy control unit 35 outputs the generated traveling control information for the host vehicle to the traveling control unit 40. That is, when the convoy configuration information of the host vehicle is updated, the traveling control of the host vehicle is performed in accordance with the updated content.

The vehicle state managing unit 36 manages the driving control information of the host vehicle similarly to the vehicle state managing unit 23 illustrated in FIG. 11. The vehicle state managing unit 36 outputs the driving control information of the host vehicle to the convoy forming unit 33 and the cut-in acceptability determining unit 39.

The preceding vehicle detecting unit 37 generates the preceding vehicle information similarly to the preceding vehicle detecting unit 25 illustrated in FIG. 11. The preceding vehicle detecting unit 37 outputs the generated preceding vehicle information to the convoy managing unit 34 and the cut-in acceptability determining unit 39.

The cut-in vehicle detecting unit 38 generates the cut-in vehicle information similarly to the cut-in vehicle detecting unit 24 illustrated in FIG. 11. The cut-in vehicle detecting unit 38 outputs the generated cut-in vehicle information to the convoy managing unit 34 and the cut-in acceptability determining unit 39.

In response to the cut-in vehicle information notification of which is provided from the cut-in vehicle detecting unit 38 and the cut-in acceptability determination request notification of which is provided from the convoy travel management device 30 of the different vehicle, the cut-in acceptability determining unit 39 determines whether or not the host vehicle can cause a vehicle outside the convoy (that is, a cut-in vehicle) to cut in front of the host vehicle. The cut-in acceptability determining unit 39 outputs the determination result to the convoy managing unit 34 as the cut-in acceptability information. The cut-in acceptability determination by the cut-in acceptability determining unit 39 is performed on the basis of the driving control information of the host vehicle notification of which is provided from the vehicle state managing unit 36 of the host vehicle. Further, the cut-in acceptability determining unit 39 notifies the convoy travel management device 30 of the different vehicle of a cut-in acceptability determination request depending on the result of the cut-in acceptability determination. Specifically, when the cut-in vehicle cannot cut in front of the host vehicle, the cut-in acceptability determining unit 39 notifies a preceding vehicle of the host vehicle of the cut-in acceptability determination request. Details of the operation of the cut-in acceptability determining unit 39 will be described later.

Similarly to the traveling control unit 26 illustrated in FIG. 11, the traveling control unit 40 notifies each component (not illustrated) of the host vehicle of control information on the basis of the traveling control information for the host vehicle notification of which is provided from the convoy control unit 35.

Next, the operations of the cut-in acceptability determining unit 39 and the convoy managing unit 34 when there is a cut-in vehicle will be described in detail.

(11) A case where a cut-in vehicle newly occurs

In the case (11), the convoy travel management device 30 determines a vehicle that increases an inter-vehicle distance to cause a cut-in vehicle to cut in the convoy, and controls traveling of the determined vehicle and the following vehicles behind the determined vehicle.

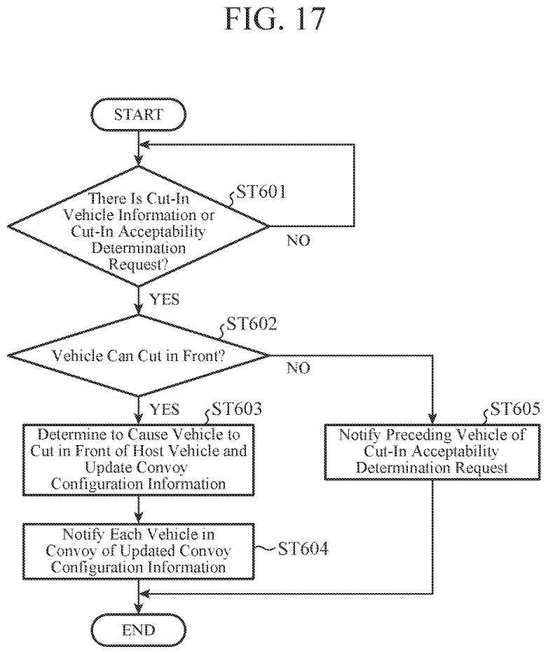

FIG. 17 is a flowchart illustrating an operation example of the cut-in acceptability determining unit 39 and the convoy managing unit 34 in the case (11). At the start of the operation illustrated in the flowchart of FIG. 17, the vehicles #1 to #N have started convoy travel.

When notification of cut-in vehicle information is provided from the cut-in vehicle detecting unit 38 or notification of a cut-in acceptability determination request is provided from the convoy travel management device 30 of the different vehicle in step ST601 (step ST601 “YES”), the processing of the cut-in acceptability determining unit 39 proceeds to step ST602, and otherwise (step ST601 “NO”), the processing of the cut-in acceptability determining unit 39 returns to step ST601.

In step ST602, the cut-in acceptability determining unit 39 determines whether it is possible to cut in front of the host vehicle, using the driving control information of the host vehicle. When it is possible to cut in front of the host vehicle, that is, when the host vehicle is a vehicle that can be a leading vehicle (step ST602 “YES”), the processing of the cut-in acceptability determining unit 39 proceeds to step ST603. On the other hand, when it is impossible to cut in front of the host vehicle, that is, when the host vehicle is a vehicle that cannot be a leading vehicle (step ST602 “NO”), the processing of the cut-in acceptability determining unit 39 proceeds to step ST605.

In step ST603, the cut-in acceptability determining unit 39 notifies the convoy managing unit 34 of cut-in acceptability information. The convoy managing unit 34 updates the convoy configuration information by setting the state of traveling control of the host vehicle to “there is a cut-in vehicle ahead”.

In step ST604, the convoy managing unit 34 notifies the convoy control unit 35 of the host vehicle and the convoy control unit 35 of the different vehicle of the updated convoy configuration information. The convoy control unit 35 generates traveling control information for the host vehicle on the basis of the updated convoy configuration information. When the state of traveling control of the host vehicle is “there is a cut-in vehicle ahead”, the convoy control unit 35 generates traveling control information for temporarily decelerating in such a way as to increase the inter-vehicle distance to the preceding vehicle in order to cause the cut-in vehicle to cut in front.

When notification of updated convoy configuration information is provided from the convoy managing unit 34 of the different vehicle to the convoy control unit 35 of the host vehicle, the convoy control unit 35 of the host vehicle generates traveling control information for the host vehicle on the basis of the convoy configuration information. When the state of the preceding vehicle traveling ahead of the host vehicle in the convoy is “there is a cut-in vehicle ahead”, the convoy control unit 35 generates traveling control information for temporarily decelerating in response to the temporary deceleration of the preceding vehicle.

In step ST605, the cut-in acceptability determining unit 39 notifies the convoy travel management device 30 mounted on the preceding vehicle of the host vehicle of a cut-in acceptability determination request.

(12) A case where the cut-in vehicle stops cutting in after occurrence of the above (11)

In the case (12), the convoy travel management device 30 causes the vehicle having kept the increased inter-vehicle distance to return to the original inter-vehicle distance.

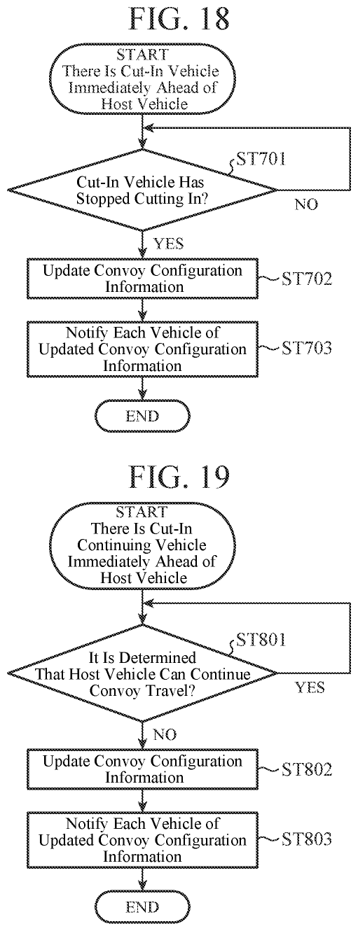

FIG. 18 is a flowchart illustrating an operation example of the convoy managing unit 34 in the case (12). At the start of the operation shown in the flowchart of FIG. 18, there is a cut-in vehicle immediately ahead of the host vehicle in a lane different from the lane of the host vehicle. The host vehicle is a vehicle that can be a leading vehicle.

When the cut-in vehicle detecting unit 38 detects that the cut-in vehicle has stopped cutting in at step ST701, the cut-in vehicle detecting unit 38 notifies the convoy managing unit 34 of cut-in vehicle information indicating that the cutting in is stopped (step ST701 “YES”). If not notified of the cut-in vehicle information (step ST701 “NO”), the convoy managing unit 34 repeats the operation of step ST701.

In step ST702, the convoy managing unit 34 updates the convoy configuration information by setting the state of traveling control of the host vehicle to “following-travel driving behind the preceding vehicle” from “there is a cut-in vehicle ahead”.

In step ST703, the convoy managing unit 34 notifies the convoy control unit 35 of the host vehicle and the convoy control unit 35 of the different vehicle of the updated convoy configuration information.

(13) A case where the cut-in vehicle continues cutting in after occurrence of the above (1)

In the case (13), the convoy travel management device 30 sets the host vehicle as a new leading vehicle, and organizes the host vehicle and the following vehicles behind the host vehicle as a new convoy.

FIG. 19 is a flowchart illustrating an operation example of the convoy managing unit 34 in the case (13). At the start of the operation shown in the flowchart of FIG. 19, there is a cut-in vehicle immediately ahead of the host vehicle in a lane different from the lane of the host vehicle. The host vehicle is a vehicle that can be a leading vehicle.

In step ST801, the convoy managing unit 34 determines whether or not the host vehicle can continue the convoy travel, using the preceding vehicle information notification of which is provided from the preceding vehicle detecting unit 37, or the like. Since the determination method used by the convoy managing unit 34 is the same as the determination method used by the convoy managing unit 14 of the first embodiment, the description thereof will be omitted. When the host vehicle can continue the convoy travel (step ST801 “YES”), the processing of the convoy managing unit 34 returns to step ST801. If the host vehicle cannot continue the convoy travel (step ST801 “NO”), the processing of the convoy managing unit 34 proceeds to step ST802.

In step ST802, the convoy managing unit 34 updates the convoy configuration information by setting the state of traveling control of the host vehicle to “driving control to be performed (autonomous driving, remote driving, manual driving, etc.)” from “there is a cut-in vehicle ahead” and further setting information indicating “it is the leading vehicle”.

In step ST803, the convoy managing unit 34 notifies the convoy control unit 35 of the host vehicle and the convoy control unit 35 of the different vehicle of the updated convoy configuration information.

(14) A case where the cut-in vehicle stops cutting in after the new convoy formation of the above (3)

In the case (14), the convoy travel management device 30 returns the first convoy and the second convoy separated by the cut-in vehicle to the original one convoy.

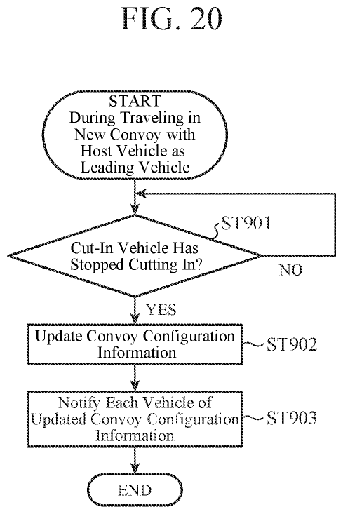

FIG. 20 is a flowchart illustrating an operation example of the convoy managing unit 34 in the case (14). At the start of the operation illustrated in the flowchart of FIG. 20, the first convoy and the second convoy with the host vehicle as the new leading vehicle are traveling. Further, the cut-in vehicle is traveling between the first convoy and the second convoy.

In step ST901, when the cut-in vehicle detecting unit 38 detects that the cut-in vehicle traveling ahead of the host vehicle has stopped cutting in, the cut-in vehicle detecting unit 38 notifies the convoy managing unit 34 of cut-in vehicle information indicating that the cutting in is stopped (step ST901 “YES”). If not notified of the cut-in vehicle information (step ST901 “NO”), the convoy managing unit 34 repeats the operation of step ST901.

In step ST902, the convoy managing unit 34 updates the convoy configuration information by setting the state of traveling control of the host vehicle to “travel following the preceding vehicle” from the “driving control to be performed” and further setting information indicating “it is not the leading vehicle”.

In step ST903, the convoy managing unit 34 notifies the convoy control unit 35 of the host vehicle and the convoy control unit 35 of the different vehicle of the updated convoy configuration information.

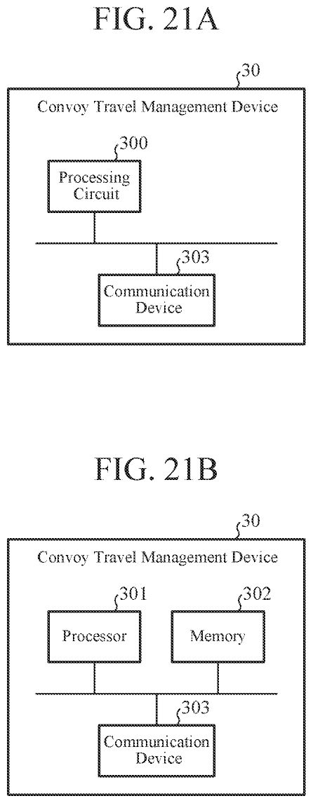

FIGS. 21A and 21B are diagrams each illustrating a hardware configuration example of the convoy travel management device 30 according to the second embodiment. The receiving unit 31 and the transmission unit 32 in the convoy travel management device 30 correspond to a communication device 303. The functions of the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40 in the convoy travel management device 30 are implemented by a processing circuit. That is, the convoy travel management device 30 includes a processing circuit for implementing the above functions. The processing circuit may be a processing circuit 300 as dedicated hardware, or may be a processor 301 that executes a program stored in a memory 302.

As illustrated in FIG. 21A, in a case where the processing circuit is dedicated hardware, the processing circuit 300 corresponds to, for example, a single circuit, a composite circuit, a programmed processor, a parallel programmed processor, ASIC, FPGA, or a combination thereof. The functions of the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40 may be implemented by a plurality of processing circuits 300, or the functions of the respective units may be collectively implemented by one processing circuit 300.

As illustrated in FIG. 21B, when the processing circuit is the processor 301, the functions of the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40 are implemented by software, firmware, or a combination of software and firmware. The software or firmware is described as a program and stored in the memory 302. The processor 301 reads and executes the program stored in the memory 302 to implement the function of each unit. That is, the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40 include the memory 302 for storing a program that results in execution of steps illustrated in the flowcharts of FIGS. 17 to 20 when executed by the processor 301. It can also be said that this program causes a computer to execute the procedures or methods performed by the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40.

Note that the functions of the convoy forming unit 33, the convoy managing unit 34, the convoy control unit 35, the vehicle state managing unit 36, the preceding vehicle detecting unit 37, the cut-in vehicle detecting unit 38, the cut-in acceptability determining unit 39, and the traveling control unit 40 may be partially implemented by dedicated hardware and partially implemented by software or firmware. As described above, the processing circuit in the convoy travel management device 30 can implement the above-described functions by hardware, software, firmware, or a combination thereof.

Here, the processor 301 is a CPU, a processing device, an arithmetic device, a microprocessor, or the like.

The memory 302 may be a nonvolatile or volatile semiconductor memory such as a RAM, a ROM, an EPROM, or a flash memory, a magnetic disk such as a hard disk or a flexible disk, or an optical disk such as a CD or a DVD.

As described above, the convoy travel management device 30 according to the second embodiment includes the vehicle state managing unit 36, the convoy forming unit 33, the cut-in acceptability determining unit 39, the convoy managing unit 34, the convoy control unit 35, and the traveling control unit 40. The vehicle state managing unit 36 manages information indicating a driving control function of the host vehicle and information indicating a state of an occupant of the host vehicle as the first driving control information. The convoy forming unit 33 collects, from at least one different vehicle, information indicating a driving control function of the at least one different vehicle and information indicating a state of an occupant of the at least one different vehicle as the second driving control information. The convoy forming unit 33 determines the traveling order in the convoy of the host vehicle and the at least one different using the first driving control information and the second driving control information so that a vehicle that can be a leading vehicle is disposed at a head of the convoy and an inside of the convoy. The convoy forming unit 33 notifies the at least one different vehicle of traveling order information indicating the traveling order. When there is occurrence of a cut-in vehicle to an area around the host vehicle performing convoy travel in accordance with the notification from the convoy forming unit 33, the cut-in acceptability determining unit 39 determines whether or not the host vehicle can be a leading vehicle using the first driving control information. When the host vehicle can be the leading vehicle and the cut-in vehicle continues cutting in, the convoy managing unit 34 notifies the at least one different vehicle of convoy configuration information. The convoy configuration information indicates that the convoy is to be divided into a first convoy ahead of the cut-in vehicle and a second convoy behind the cut-in vehicle and that the host vehicle is to become a leading vehicle of the second convoy. The convoy control unit 35 generates traveling control information including an instruction to cause the cut-in vehicle to cut in front of the host vehicle and an instruction to be the leading vehicle of the second convoy, on the basis of the convoy configuration information. The traveling control unit 40 causes the host vehicle to perform the convoy travel in accordance with the traveling order determined by the convoy forming unit 33. The traveling control unit 40 causes the cut-in vehicle to cut in front of the host vehicle and sets the host vehicle as the leading vehicle of the second convoy, in accordance with the traveling control information generated by the convoy control unit 35. When the host vehicle is a vehicle that can be a leading vehicle in the convoy, the convoy travel management device 30 causes the cut-in vehicle to cut in front of the host vehicle, so that the host vehicle and the following vehicles behind the host vehicle can continue the convoy travel as the second convoy. In addition, since the convoy of the vehicles #1 to #N does not disturb the traveling of a vehicle outside the convoy, the degree of freedom of the traveling of the vehicle outside the convoy is improved. In addition, when the cut-in vehicle that has cut in the convoy does not continue the cutting in and immediately stops the cutting in, the convoy travel management device 30 does not divide the convoy. Therefore, it is possible to reduce the processing cost related to the convoy reorganization, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

In addition, the convoy forming unit 33 of the second embodiment regularly arranges vehicles each of which can be the leading vehicle in the convoy. As a result, the convoy travel management device 30 can easily cause the cut-in vehicle to cut in at any position in the convoy. In addition, a vehicle outside the convoy easily cuts in at any position in the convoy, and thus the degree of freedom of traveling of the vehicle outside the convoy is improved.

In addition, in a case where the host vehicle can be the leading vehicle, the traveling control unit 40 of the second embodiment sets, when the host vehicle cannot continue traveling while following, the host vehicle as the leading vehicle of the second convoy in accordance with the traveling control information generated by the convoy control unit 35. As a result, the convoy travel management device 30 can reduce the processing cost related to the convoy reorganization when the cut-in vehicle that is about to cut in the convoy does not actually cut in, the burden on the driver when the leading vehicle of the new convoy travels by the manual driving, the burden on the operator when the leading vehicle of the new convoy travels by the remote driving, the burden on the communication resources when the leading vehicle of the new convoy travels by the autonomous driving, and the like.

In addition, when the cut-in vehicle recedes from an area in front of the host vehicle, the convoy managing unit 34 of the second embodiment notifies the at least one different vehicle of convoy information indicating that the first convoy and the second convoy are to be returned to the original one convoy. The traveling control unit 40 controls the host vehicle in such a way as to follow a rearmost vehicle of the first convoy. As a result, when the cut-in vehicle stops cutting in the convoy, the convoy travel management device 30 can return the vehicles #1 to #N to the original convoy.

Note that, within the scope of the present disclosure, the present disclosure can freely combine the embodiments, modify any component of the embodiments, or omit any component of the embodiments.

In the first and second embodiments, the following-travel driving, which is one of the driving control functions of the host vehicle, is a function in which the host vehicle travels in such a way as to follow the preceding vehicle immediately ahead on the basis of information detected by a sensor or the like mounted on the host vehicle. However, it is not limited thereto. The function of the following-travel driving may be, for example, a function in which the host vehicle travels in such a way as to follow the leading vehicle by exchanging position information and the like between the leading vehicle of the convoy and the host vehicle that is the following vehicle in the convoy through inter-vehicle communication or the like. In this case, for example, the preceding vehicle detecting unit 25 and the preceding vehicle detecting unit 37 determine that there is a possibility of losing sight of the leading vehicle when the distance between the leading vehicle and the host vehicle is increased due to the cut-in vehicle cutting in the convoy and thereby the communication quality of the vehicle-to-vehicle communication or the like is deteriorated to be lower than the predetermined quality, and determine that the leading vehicle is lost when the vehicle-to-vehicle communication or the like is interrupted.

### INDUSTRIAL APPLICABILITY

Since the convoy travel management system according to the present disclosure causes a cut-in vehicle to cut in front of a vehicle that can be a leading vehicle among following vehicles in a convoy, the convoy travel management system is suitable for use in a convoy travel management system or the like that continues traveling of a convoy formed by a plurality of vehicles having different driving control functions.

### REFERENCE SIGNS LIST

10: convoy travel management server, 11: receiving unit, 12: transmission unit, 13: convoy forming unit, 14: convoy managing unit, 15: convoy control unit, 20: vehicle control device, 21: receiving unit, 22: transmission unit, 23: vehicle state managing unit, 24: cut-in vehicle detecting unit, 25: preceding vehicle detecting unit, 26: traveling control unit, 30: convoy travel management device, 31: receiving unit, 32: transmission unit, 33: convoy forming unit, 34: convoy managing unit, 35: convoy control unit, 36: vehicle state managing unit, 37: preceding vehicle detecting unit, 38: cut-in vehicle detecting unit, 39: cut-in acceptability determining unit, 40: traveling control unit, 100, 200, 300: processing circuit, 101, 201, 301: processor, 102, 202, 302: memory, 103, 203, 303: communication device, #1 to #9, #N: vehicle, #10: cut-in vehicle

1. A vehicle control device comprising:
processing circuitry
to manage information indicating a driving control function of a host vehicle and information indicating a state of an occupant of the host vehicle as driving control information and notify a convoy travel management server of the driving control information;
to notify the convoy travel management server of cut-in vehicle information when detecting occurrence of a cut-in vehicle to a convoy including the host vehicle;
to, in a case where the convoy travel management server determines a traveling order in the convoy of a plurality of vehicles including the host vehicle so that a vehicle and another vehicle each of which can be a leading vehicle are respectively disposed at a head of the convoy and an inside of the convoy using driving control information collected from each of the plurality of vehicles, and where the convoy travel management server notifies each of the plurality of vehicles of traveling order information indicating the traveling order,
cause the host vehicle to perform convoy travel in accordance with the traveling order indicated by the notification; and
to, in a case where the convoy travel management server determines, from among following vehicles that are following a leading vehicle of the convoy, a new leading vehicle that can be another leading vehicle using the driving control information in response to notification of cut-in vehicle information from any of the plurality of vehicles, and where the convoy travel management server divides the convoy into a first convoy ahead of the cut-in vehicle and a second convoy behind the cut-in vehicle when the cut-in vehicle continues cutting in, and notifies the new leading vehicle of traveling control information including an instruction to cause the cut-in vehicle to cut in front of the new leading vehicle and an instruction to be a leading vehicle of the second convoy,
cause the cut-in vehicle to cut in front of the host vehicle and set the host vehicle as the leading vehicle of the second convoy when the host vehicle is the new leading vehicle.

2. A convoy travel management device comprising:
processing circuitry
to manage information indicating a driving control function of a host vehicle and information indicating a state of an occupant of the host vehicle as first driving control information;
to collect, from at least one different vehicle, information indicating a driving control function of the at least one different vehicle and information indicating a state of an occupant of the at least one different vehicle as second driving control information, determine a traveling order in a convoy of the host vehicle and the at least one different vehicle so that a vehicle and another vehicle each of which can be a leading vehicle are respectively disposed at a head of the convoy and an inside of the convoy using the first driving control information and the second driving control information, and notify the at least one different vehicle of traveling order information indicating the traveling order;
to determine whether or not the host vehicle can be a leading vehicle using the first driving control information when there is occurrence of a cut-in vehicle to an area around the host vehicle performing convoy travel in accordance with the traveling order information;
to notify the at least one different vehicle of convoy configuration information when the host vehicle can be the leading vehicle and the cut-in vehicle continues cutting in, the convoy configuration information indicating that the convoy is to be divided into a first convoy ahead of the cut-in vehicle and a second convoy behind the cut-in vehicle and that the host vehicle is to become a leading vehicle of the second convoy;
to generate traveling control information including an instruction to cause the cut-in vehicle to cut in front of the host vehicle and an instruction to be the leading vehicle of the second convoy, on a basis of the convoy configuration information; and
to cause the host vehicle to perform the convoy travel in accordance with the traveling order determined, and cause the cut-in vehicle to cut in front of the host vehicle and set the host vehicle as the leading vehicle of the second convoy in accordance with the traveling control information generated.

3. The convoy travel management device according to claim 2, wherein the traveling order information causes vehicles each of which can be the leading vehicle to be regularly disposed in the convoy.

4. The convoy travel management device according to claim 2, wherein, in a case where the host vehicle can be the leading vehicle, the processing circuitry, when the host vehicle cannot continue traveling while following, the host vehicle as the leading vehicle of the second convoy in accordance with the traveling control information generated.

5. The convoy travel management device according to claim 2, wherein
when the cut-in vehicle recedes from an area in front of the host vehicle, the processing circuitry notifies the at least one different vehicle of convoy configuration information indicating that the first convoy and the second convoy are to be returned to one original convoy, and
the processing circuitry causes the host vehicle to follow a rearmost vehicle of the first convoy.

6. A convoy travel management method for controlling traveling of a plurality of vehicles that perform convoy travel, the convoy travel management method comprising:
collecting, from each of the plurality of vehicles, information indicating a driving control function of a corresponding one of the plurality of vehicles and information indicating a state of an occupant of the corresponding one of the plurality of vehicles as driving control information, determining a traveling order in a convoy of the plurality of vehicles so that a vehicle and another vehicle each of which can be a leading vehicle are respectively disposed at a head of the convoy and an inside of the convoy using the collected driving control information, and notifying each of the plurality of vehicles of traveling order information indicating the traveling order;
determining, from among following vehicles that are following a leading vehicle of the convoy, a new leading vehicle that can be another leading vehicle using the driving control information in response to notification of cut-in vehicle information indicating occurrence of a cut-in vehicle to the convoy from any of the plurality of vehicles that are performing the convoy travel in accordance with the traveling order information, and dividing the convoy into a first convoy ahead of the cut-in vehicle and a second convoy behind the cut-in vehicle when the cut-in vehicle continues cutting in; and
notifying the new leading vehicle of traveling control information including an instruction to cause the cut-in vehicle to cut in front of the new leading vehicle and an instruction to be a leading vehicle of the second convoy.

7. The convoy travel management method according to claim 6, wherein the traveling order information causes vehicles each of which can be the leading vehicle to be regularly disposed in the convoy.

8. The convoy travel management method according to claim 6, further comprising:
dividing the convoy into the first convoy ahead of the cut-in vehicle and the second convoy behind the cut-in vehicle when the new leading vehicle cannot continue traveling while following.

9. The convoy travel management method according to claim 6, further comprising:
when notified of cut-in vehicle information indicating that the cut-in vehicle has stopped cutting in from any of the vehicles constituting the first convoy and the second convoy that are performing convoy travel in accordance with the traveling order, returning the first convoy and the second convoy to one original convoy, and
notifying the new leading vehicle of traveling control information including an instruction to follow a rearmost vehicle of the first convoy.
